(19) United States
(12) Patent Application Publication
(10) Pub. No.: US 2002/0002443 A1
(43) Pub. Date: Jan. 3, 2002

(54) MULTI-LEVEL ARCHITECTURE FOR MONITORING AND CONTROLLING A FUNCTIONAL SYSTEM

(76) Inventors: RONALD M. AMES, PARKER, CO (US); THOMAS ALLAN YAP, AURORA, CO (US)

Correspondence Address: Thomas W. Hanson, LLC, 3555 S. Sherman St., Suite 1, Englewood, CO, 80110, US

(21) Appl. No.: 09/169,825

(22) Filed: Oct. 10, 1998

(51) Int. Cl. G06F 11/00

(52) U.S. Cl. 702/188

(57) ABSTRACT

A system for monitoring and reporting the health and status of an independent functional system which collects, transmits, and analyzes data on the occurrence of events within the monitored system. The system incorporates a monitoring node; a data collection node; a host computer; status monitoring means; data management means; with communication links coupling the monitoring node(s) to the data collection node(s), and the data collection node(s) to the host computer. The status monitoring means and data management means are distributed across the nodes as software, firmware, or hardware implementations. The monitoring node includes discrete, and possibly analog, inputs which can be connected to the functional component being monitored. The analysis can include validation of input values against acceptable values; verification of the relative timing of two or more input events; and verification of the sequence of input events and may utilize the data from a single monitoring node; two or more monitoring nodes attached to the same data collection node; or two or more monitoring nodes attached to different data collection nodes. The system may include non-volatile storage of event data allowing the analysis to utilize stored data in addition to newly received data.

### FIELD OF THE INVENTION

The invention relates to monitoring systems and specifically to architectures for computer based systems used to monitoring a separate functional system. Alternatively the monitoring system can be integrated with the functional system.

### BACKGROUND OF THE INVENTION

In most large urban areas, providing parking is a major business. Surface lots and parking structures provide parking to hourly, daily, and long term patrons. Where demand is high, the parking revenue that a lot can generate may exceed the revenue that could be generated by retail stores in the same location.

Despite the potential and actual revenue generated by the parking industry, that industry largely manages their resources using systems that are antiquated by current standards. Often, no access control is provided at all. Either the honor system, or a roving lot attendant, enforces the payment of fees. Where access control is provided, it is most often old, electromechanical devices such as gates and ticket dispensers. Each entrance or exit in a lot is independent of the others with no integration. This often drives the lot to use a single exit point for collection of revenue, because no coordination is possible.

The devices that are used typically do not incorporate microprocessors or microcomputers and have no self-monitoring capability. Physical inspection is required to detect problems with the equipment. The practical implication of this is that the device often fails completely before the problem is detected. A failed device often means that patrons are blocked from entering the lot or are allowed to exit without paying. Either situation results in lost revenues. This problem is compounded by the fact that the devices are exposed to the weather year round and may be located remotely from the attendants station, reducing the likelihood of inspection or detection of problems. The devices may also be subject to vandalism either by passers-by or by patrons.

All of these problems result in lost revenue to the parking provider. This revenue loss could be decreased by providing integrated systems of “smart” devices. These devices could then report transactions, such as a patron entering or exiting, to a central computer. This would allow improved coordination between the access points to the lot. The devices could also report on their health and status, allowing problems to be detected as, or even before, they occur.

Fraud by patrons and attendants is also a problem. Fees may not be paid by the patron. Attendants may pocket collected fees. Without monitoring, these events are almost impossible to detect. Smart devices connected to a central computer could also help alleviate these problems by tracking the transactions. Reporting of these transactions would allow at least a prediction of expected revenue based on the number and timing of patron arrivals and departures. This could be compared to actual revenues to indicate a possible problem.

Where a single parking vendor operates multiple lots or structures and caters to long-term parking patrons, new opportunities for fraud exist, or opportunities to provide a service are lost. It might be desirable to allow a patron to use any of several lots with the same access card. However, this raises the possibility that the patron may park in one lot, and then loan their card to a friend to then parks in a separate lot. Unless all of the lots which accept the card are integrated, sharing transaction data, such fraud is undetectable. This typically leads to the decision to not provide this type of service. A system wide integrated access control system would enable this type of service without risk of loss.

Unfortunately, the cost of replacing the existing systems with such integrated, smart devices and their supporting computer system is usually prohibitive. While the existing devices may be old, they still represent a major investment and are likely perceived as still functioning adequately. Without hard data supporting an increase in revenue, replacement may be viewed as not cost effective.

Existing functional systems, other than parking lot access control, also face similar problems. Crossing gates and lights for railroad and light rail crossing are similarly subject to failure without detection. Process control and automated manufacturing systems, such as assembly lines, utilize stand alone electromechanical components which are subject to undetected failure. Here also, the replacement cost for the components is too high to justify wholesale replacement.

Other art areas are also faced with the need to provide health and status monitoring. The problem is well known in the area of computers and communications networks. Many components and systems include monitoring and reporting as part of their design. However, the techniques used often require integration into the design of the components at the lowest levels. Such monitoring can not be added onto a device after it is put into operation.

There is a need for a system which can be added to existing electromechanical devices to provide health and status reporting, monitoring, and sharing of data between devices. The system should be a retrofit installation that works in combination with the existing devices. Alternatively, it could replace certain components of the device without impacting the remaining components. The system should provide a monitoring and reporting path which is independent of the existing system. It should also be able to connect to more advanced devices such as electronic card readers and computers used for fee calculation. Ideally the system should allow for a continued growth path as improvements to the functional system, such as older devices being replaced with new smart devices, are reflected in increased performance and capability of the monitoring system. Ideally, such a system could assume control of the functional devices, either on a regular or emergency basis, in addition to providing monitoring.

### SUMMARY OF THE INVENTION

The present invention is directed to a system for monitoring and reporting the health and status of an independent functional system. According to the invention there is provided a monitoring node; a data collection node; a host computer; status monitoring means; and data management means; with communication links coupling the monitoring node(s) to the data collection node(s), and the data collection node(s) to the host computer. The status monitoring means and data management means are distributed across the nodes as software, firmware, or hardware implementations. The system collects, transmits, and analyzes data on the occurrence of events within the monitored system.

According to an aspect of the invention the monitoring node incorporates discrete inputs which can be connected to the functional component being monitored. Alternatively, the monitoring node may also incorporate analog inputs.

According to another aspect of the invention the analysis performed by the system can include validation of input values against acceptable values; verification of the relative timing of two or more input events; and verification of the sequence of input events. The analysis may utilize the data from a single monitoring node; two or more monitoring nodes attached to the same data collection node; or two or more monitoring nodes attached to different data collection nodes. The analysis may be performed on the monitoring node; data collection node; or the host computer.

Further in accordance with the invention non-volatile storage may be provided for storing input event data. The various forms of analysis may then utilize stored data in addition to newly received data.

Further in accordance with the invention, subsystems of the inventive system may be implemented as separate printed circuit boards (PCBs), or sets of boards; as separate integrated circuits (ICs); or as PCBs or ICs which combine two or more subsystems.

Still further in accordance with the invention the communications links may be redundant and may incorporate a common high level protocol comprising means to detect failed subsystems and means to synchronizes the clocks within the subsystems.

Still further in accordance with the invention, the monitoring subsystem(s) can incorporate control capabilities including discrete and analog outputs which allow the subsystem to control the functional component in addition to monitoring the component.

The advantages of such a system are that it can be retrofit to an existing system and provide an independent monitoring and reporting capability without replacing the components of the functional system. Monitoring and analysis is enabled which utilizes detected events from multiple functional components. This analysis can support the generation of immediate alarms; reallocation of resources to bypass a detected problem; and long term analysis including trending and marketing analysis. In the alternative forms, the system can also replace parts of the functional components allowing it to assume control of the functional system if desired.

The above and other features and advantages of the present invention will become more clear from the detailed description of a specific illustrative embodiment thereof, presented below in conjunction with the accompanying drawings.

### BRIEF DESCRIPTION OF THE DRAWINGS

FIG. 1 provides a pictorial representation of a simple parking lot access control system.

FIG. 2 shows the system of FIG. 1 as a block diagram.

FIG. 3 illustrates the system of FIG. 2 with the addition of the components of the inventive system.

FIG. 4A illustrates the preferred form of the sentry subsystem of the inventive system.

FIG. 4B illustrates an alternative form of the sentry subsystem.

FIG. 5 shows the relevant components of a functional component as a block diagram.

FIG. 6 illustrates the connection of a sentry subsystem to the functional component of FIG. 5.

FIG. 7A illustrates the preferred form of the watch commander subsystem of the inventive system.

FIG. 7B illustrates an alternative form of the watch commander subsystem.

FIG. 8 illustrates an example configuration of the inventive system showing the interconnecting communications links.

FIGS. 9A through 9D present the formats of various data packets utilized by the inventive system.

FIG. 10A presents the command set supported by the sentry subsystem.

FIG. 10B presents the command set supported by the watch commander subsystem.

FIG. 11 presents the software architecture of the inventive system.

FIG. 12A presents the timing diagrams for a normally functioning component of the parking system.

FIG. 12B presents the modified timing diagrams of the functional component representing increased operational times.

FIG. 12C presents the modified timing diagrams of the functional component representing increased time lapses.

FIG. 13A illustrates the normal states and transitions for a segment of the parking system.

FIG. 13B illustrates a disallowed transition in the state transition diagram of FIG. 13A.

FIG. 14A illustrates the normal states and transitions for a patron of the parking system.

FIG. 14B illustrates disallowed transitions in the patron's state transition diagram.

FIG. 15 illustrates an alternative form of the sentry subsystem incorporating output capability.

FIG. 16 illustrates the integration of the alternative form of the sentry into a functional component.

### DETAILED DESCRIPTION OF THE INVENTION

The following discussion focuses on the preferred embodiment of the invention where it provides monitoring for a parking lot or structure. However, as will be recognized by those skilled in the art, the disclosed method and apparatus are applicable to a wide variety of situations in which monitoring of existing systems is desired. The system is clearly applicable to railroad and light rail crossings; process control; and automated manufacturing.

The following is a brief glossary of terms used herein. The supplied definitions are applicable throughout this specification and the claims unless the term is clearly used in another manner.

Functional component—component of the functional system being monitored. Can range from a simple access gate up to and including a computer used to control the functional system.

Functional System—the system being monitored. In the preferred embodiment, this is a parking lot access and fee collection system. Can be any type of functional system.

Host Computer—a general purpose computer which is the top level of the inventive architecture. It handles communications with the watch commanders and hosts the transaction processing; database management; report generator; and user interface software.

Monitoring system—generally the inventive architecture.

Node—any subsystem of the monitoring system. Generally a logical communications entity corresponding to a physical subsystem.

Sentry—lowest level subsystem in the monitoring system. Responsible for direct monitoring of a functional component.

Subsystem—a sentry or watch commander.

Watch Commander—mid-level subsystem of the monitoring system. Serves as a network master for the attached sentries and reports to the host computer on demand. Can also perform independent analysis functions.

The disclosed invention is described below with reference to the accompanying figures in which like reference numbers designate like parts. In its preferred embodiment, the inventive monitoring system is optimized for retrofit to an existing control and fee collection system. In alternative embodiments, it is equally applicable to integration into new systems at chip and board level.

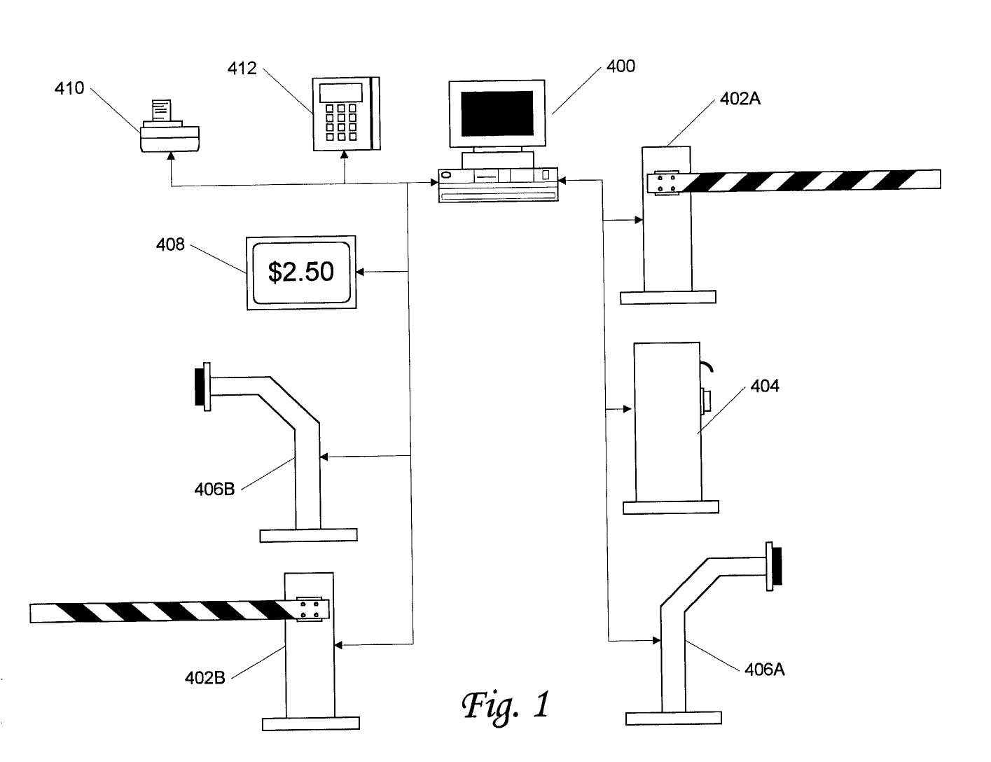

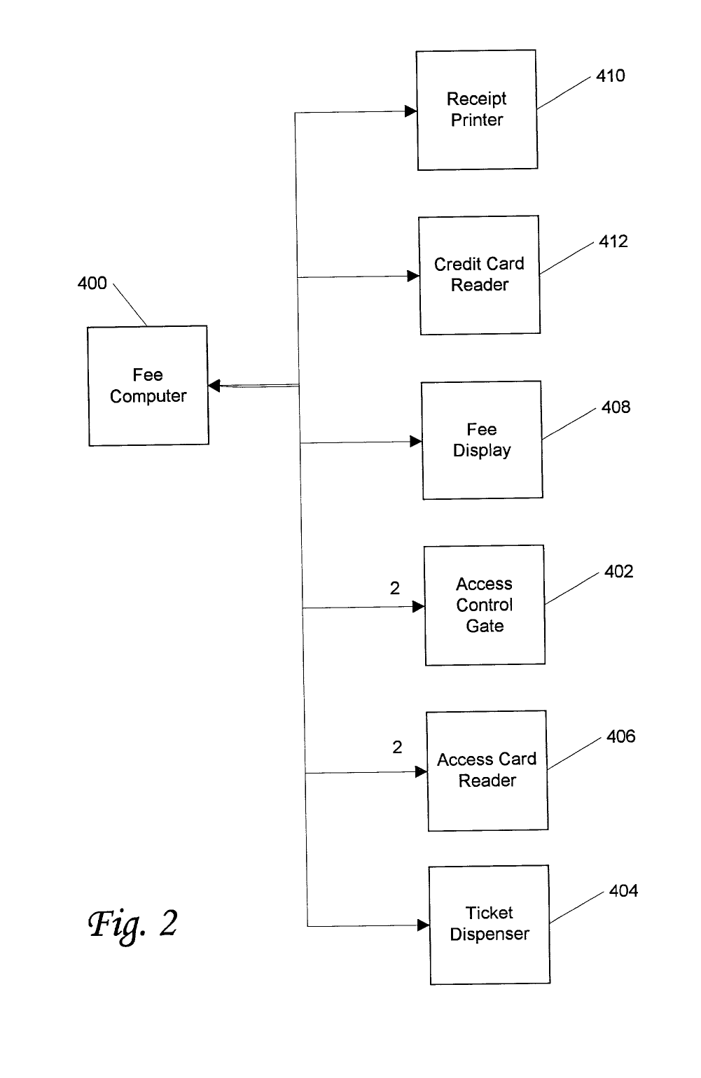

A typical parking lot access control and fee collection system is presented pictorially in FIG. 1 and as a block diagram in FIG. 2. This is a simple configuration which handles a single entry and exit point and is intended for illustration only. Additional devices and additional entry points would be used for a larger lot and such a configuration is anticipated by the invention.

The parking lot system is controlled by a fee computer, 400, and provides access control for both monthly and daily parking. Access for monthly parking is controlled via access cards. Access for daily parking is handled by a ticket issued upon entry and a cash or credit card payment when leaving. Physical ingress is controlled by access control gate, 402A. This gate is activated when one of two events occurs: a valid access card is read by access card reader, 406A; or the patron takes a ticket from the ticket dispenser, 404. The gate opens to allow a single car through, and then closes. Physical egress is controlled by access control gate, 402B. This gate activates either when: access card reader, 406B, detects a valid access card; or when manually activated by the attendant after receiving payment. The attendant determines the appropriate fee based on the entry time recorded on the ticket. This may be done manually or automatically via a ticket reader. The amount of the fee is displayed to the patron on the fee display, 408. The attendant may then accept a cash payment or a credit card payment by using credit card reader, 412. A receipt is printed by receipt printer, 410, and provided to the patron before opening the gate.

Hardware Architecture

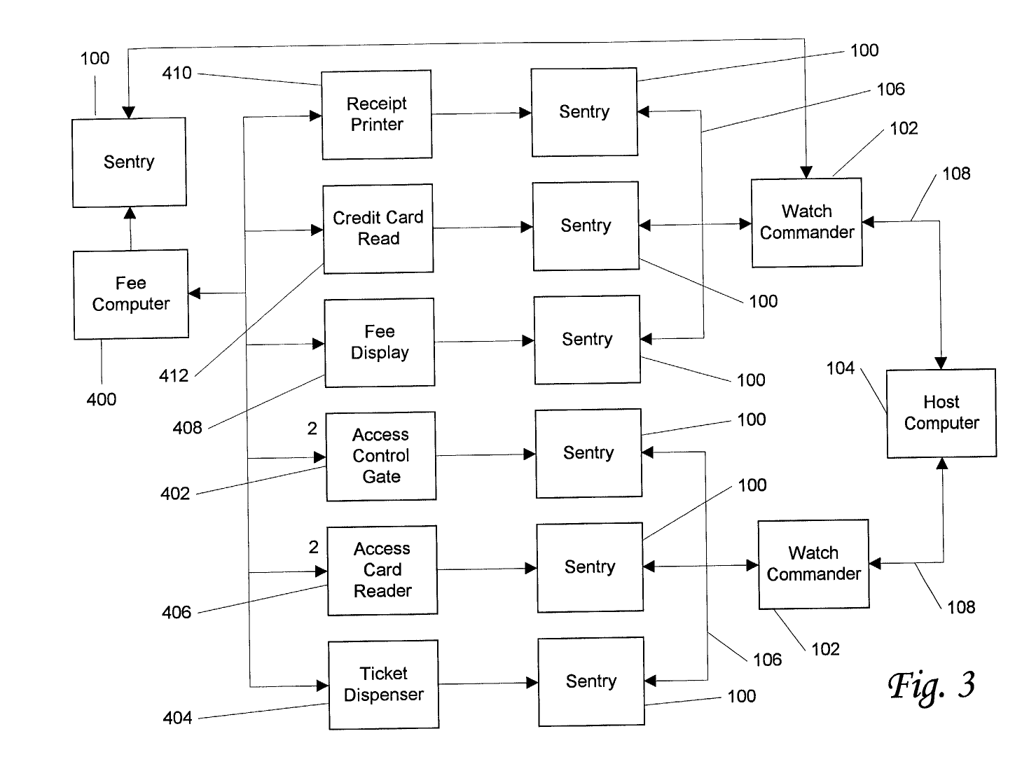

The parking lot access control and fee collection system (hereinafter the “functional system”) is supplemented by the components of the inventive system as shown in FIG. 3. Each component of the functional system is paired with a sentry subsystem, 100, which monitors the component. The sentries are connected via a communications link, 106, to a watch commander subsystem, 102. A watch commander is an intermediate data collection node which gathers data on the components of the functional system by polling the sentries and provides monitoring of the sentries themselves. In turn, the watch commanders are connected to the host computer, 104, via communications links, 108. The host computer gathers data from, and monitors, the watch commanders. The configuration of FIG. 3 is intended to be illustrative only. It would be more typical to use a single watch commander to monitor all of the functional components at a single access point to a parking lot and a host computer would monitor the entire lot or a set of lots.

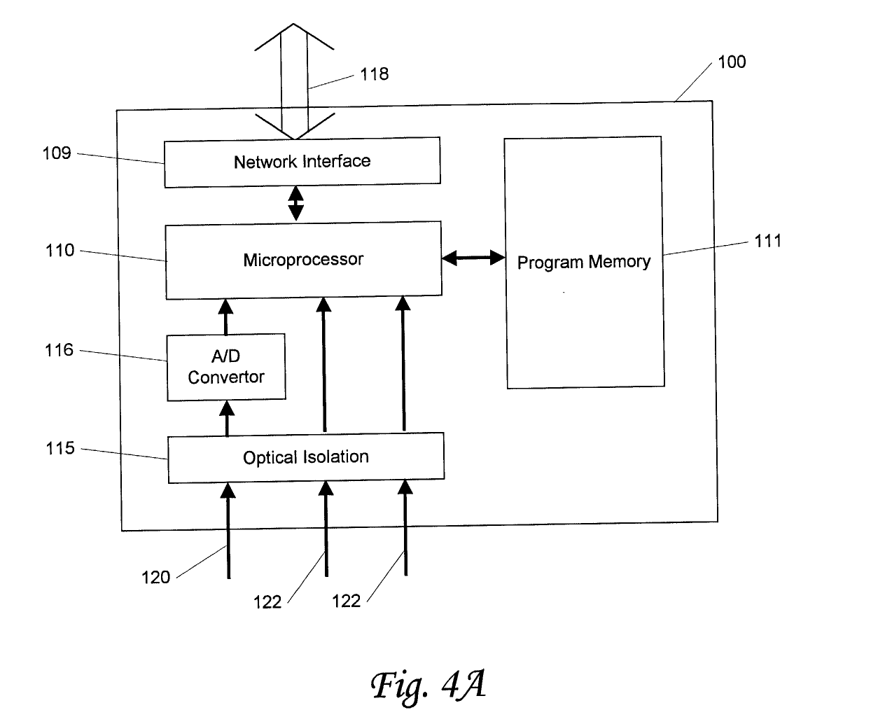

The sentry provides a hardware level interface to the functional component. Sentries may be tailored for the specific component that they are monitoring, but they all share the core architecture shown in FIG. 4A. The major components of the sentry subsystem are the network interface, 109, microcomputer, 110; program memory, 111; analog-to-digital (A/D) converters, 116; and optical isolation, 115. External interfaces include the serial data connection, 118, to the watch commander; analog inputs, 120, and discrete inputs, 122. In the preferred embodiment the sentry is built as two custom boards. In different form factors and different components, it could also be built as a single board. It is anticipated that the sentry will be migrated to an integrated circuit implementation of one or two chips and may eventually be made available as an ASIC core or macro.

In the preferred embodiment, the microcomputer, 110, is the ATMEL Corp. AT89c8051 which incorporates a CPU, random access memory, and a universal asynchronous receiver-transmitter (UART). The microcomputer provides general purpose processing of received data. Provided capabilities include buffering of received events; interpretation and implementation of received commands; and data transfer over the serial interface. A change in value of an input line, 120 or 122, is considered an event. For each such event the time of occurrence is recorded along with the device ID (pin number); sentry (node) ID; and type of event (action number). These event records are buffered within the sentry until requested by a watch commander. The program memory, 111, provides non-volatile storage for software executed on the microcomputer. In the preferred embodiment, this is EPROM memory. It may also store acceptable values, time durations, time sequences, or other data used for validation or analysis.

The network interface, 109, provides the connection, 118, to the serial communications link to the higher level watch commander. This may be RS-232, RS-422, RS-485, or any other suitable serial connection. Other communications protocols, such as parallel connections, could also be used. The A/D converters, 116, convert analog signal to digital values, allowing the sentry to monitor analog signals such as voltage and current levels. The optical isolation, 115, provides electrical isolation from the incoming signals. This prevents a voltage surge from passing into the sentry and damaging the components. Alternatively, output signals may also be provided so that the sentry can directly trigger alarms or provide control signals in response to a detected event. This is discussed below.

FIG. 4B presents an alternative embodiment of the sentry architecture which incorporates a field programmable gate array (FPGA), 114, and associated interface registers, 112. The preferred version of the FPGA is the XILINX XC4003E gate array. The gate array provides timing and control for external data collection circuits such as the A/D converters, 116, or discrete inputs, 122, and provides increased hardware level logic for processing the incoming data. An example of a function that may be implemented in the FPGA is “debouncing” an input signal. While this can also be done in software running on the microcomputer, moving this function to the FPGA frees up the microcomputer for other processing. The data inputs are received by the FPGA, processed, and transferred to the microcomputer, 110, via the interface registers, 112, upon request by the microcomputer. Since both forms of the sentry architecture support the same external interface, they are interchangeable within the system. The desired version can be selected based on needed functional capabilities and price.

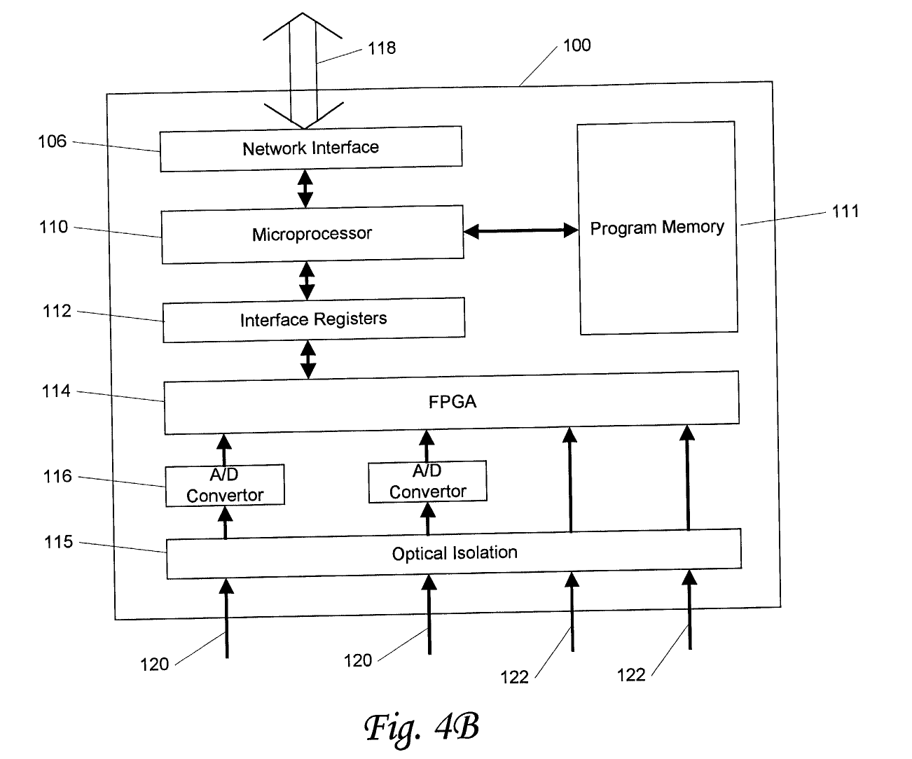

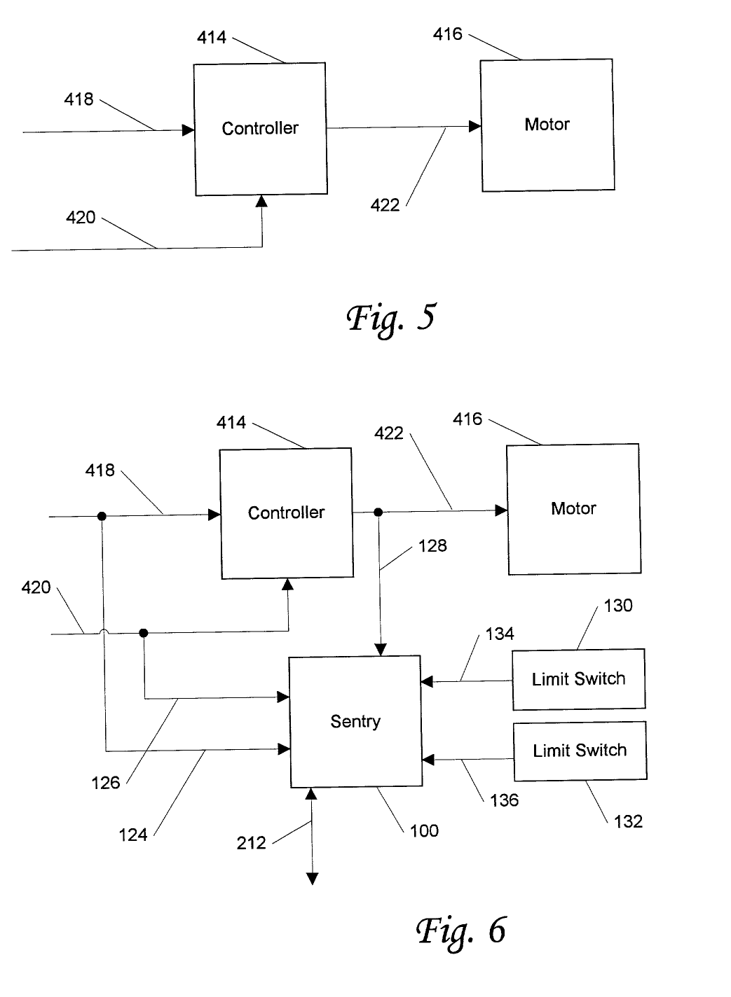

One of the basic sentry architectures is then adapted to the specific type of functional component to which is to be attached. FIG. 5 illustrates a simple functional component such as might be used to control an access gate. The controller, 414, may be as simple as a relay. In response to a control signal, 418, the controller switches the supplied power, 420, to provide switched power, 422, to the motor, 416. As shown in FIG. 6, the sentry, 100, is attached to the functional component without modifying the functional component. Discrete input, 124, provides input to the sentry indicating when the control signal is active. Analog inputs, 126, and 128, provide input on the unswitched and switched power respectively. These three signals allow the sentry to perform a variety of monitoring tasks. The simplest is the ability to determine health and status of the supplied power, reporting a failure. The sentry can also detect the control signal and the corresponding activation of the switched power line. A detected control signal, while unswitched power is available, without a matching switched power activation indicates a failure in the control unit. As a more advanced monitoring task, the sentry can also measure the duration and amperage of the power pulse used by the motor. Longer duration or higher current may indicate wear in the motor or lack of lubrication in the gate bushings. An out of limit measurement can be used to trigger preventive maintenance for the gate. Limit switches, 130, and 132, may be added to provide discrete signals indicating that the gate is in it's full open or full closed position. These are connected to discrete inputs, 134 and 136, on the sentry. These signals provide an indication that the gate is functioning normally. Failure to activate either switch may indicate a failure of the gate mechanism, a stuck gate, or excessive wear. Because the activation of either switch becomes a time stamped event, the times are available at which the gate leaves the full closed position and reaches the full open position or vice versa. These events allow the time required to open the gate to be calculated. An increase in this time can indicate a worn motor or other wear problems, and a preventive maintenance call scheduled before the gate fails. This type of monitoring is discussed more fully below.

In a similar manner, a sentry can be connected to a variety of functional components. While the installations differ in how they are coupled to the functional component, the sentry provides a uniform interface to the higher level subsystems of the inventive architecture. This greatly simplifies the interconnection of the monitoring system, allowing a wide variety of functional components to be monitored with a homogenous system. The sentry has been designed to be easily connected to various types of functional components. These include sensors, such as vehicle detector loops; access card readers for magnetic stripe, radio frequency and other types of cards; ticket dispensers; gates and barriers; fee management components such as fee computers and cash drawers; and security components such as video cameras and alarm systems.

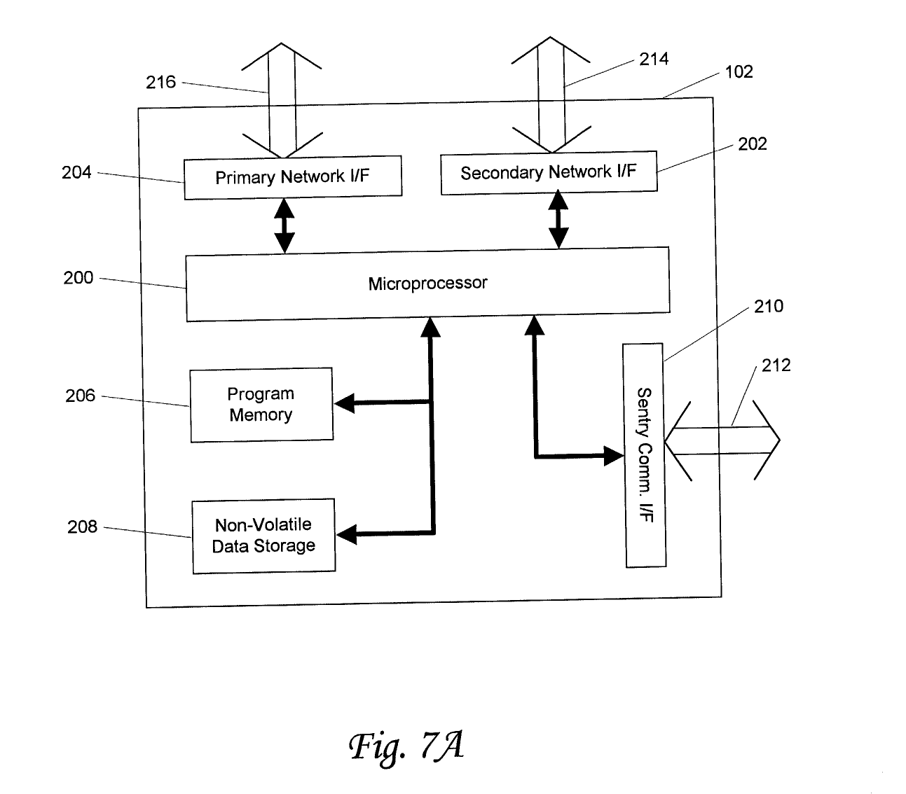

FIGS. 7A & B present the architecture of the watch commander subsystem. Like the sentry, two forms are used in the preferred embodiment with the version of FIG. 7A being the most common. The role of the watch commander is essentially that of a network master. The watch commander polls subordinate sentries, buffers their responses and transmits them to the host computer upon request. The watch commander may also analyze the received data to identify problems in the functional system. The heart of the watch commander architecture is the microcomputer, 200. The microcomputer provides general purpose processing and runs all software resident in the watch commander. Program memory, 206, provides storage for the software. Non-volatile data storage, 208, buffers received data until it is re-transmitted. The watch commander supports three separate communications interfaces. The sentry interface, 210, provides the connection, 212, to the sentry subsystems attached to that particular watch commander. The primary network interface, 204, provides the connection, 216, to the host computer. The secondary network interface, 202, provides a redundant connection, 214, to the host computer. This may be a second direct connection or may be a connection to a modem which then utilizes a telephone connection to provide the communications link. In the preferred embodiment, any of these interfaces may be implemented as RS-232, RS-422, RS-485 or any other appropriate serial connection. Other communications protocols, such as parallel connections, could clearly also be used.

The architecture of FIG. 7B is a hybrid design which incorporates features of both the watch commander and sentry into a single subsystem. This is appropriate for a smaller system where high capacity is not required. The architecture is essentially that of the watch commander as presented in FIG. 5A with the addition of a secondary microcomputer, 218; a second program memory, 220; one or more analog to digital converters, 222; optical isolation, 224; and analog, 226, and discrete, 228, inputs. The secondary microcomputer assumes control of the sentry communications interface, 212, to external sentries, and also performs the duties of a sentry as described above. It is coupled to the analog and discrete inputs, allowing it to monitor a functional component directly. This design may be implemented within a single printed circuit board, or set of boards, or even within a single integrated circuit.

The host computer, 104 in FIG. 3, is a general purpose computer capable of providing user interface, data base, and serial communications capabilities. In the preferred embodiment, this is a personal computer class machine. If desired a workstation class, minicomputer, or even larger may be used. Since no custom hardware component are needed, almost any commercially available computer system can be used as the host.

Communication and Commanding

Communication between the subsystems of the inventive system is handled by a layered protocol. The lower level is selected from among a set of standard asynchronous serial protocols which include RS-232, RS-422, RS-485, and others. The higher level is a custom protocol developed for the inventive system. A feature of the invention is that different low level protocols may be used for different connections, with the high level protocol providing uniformity

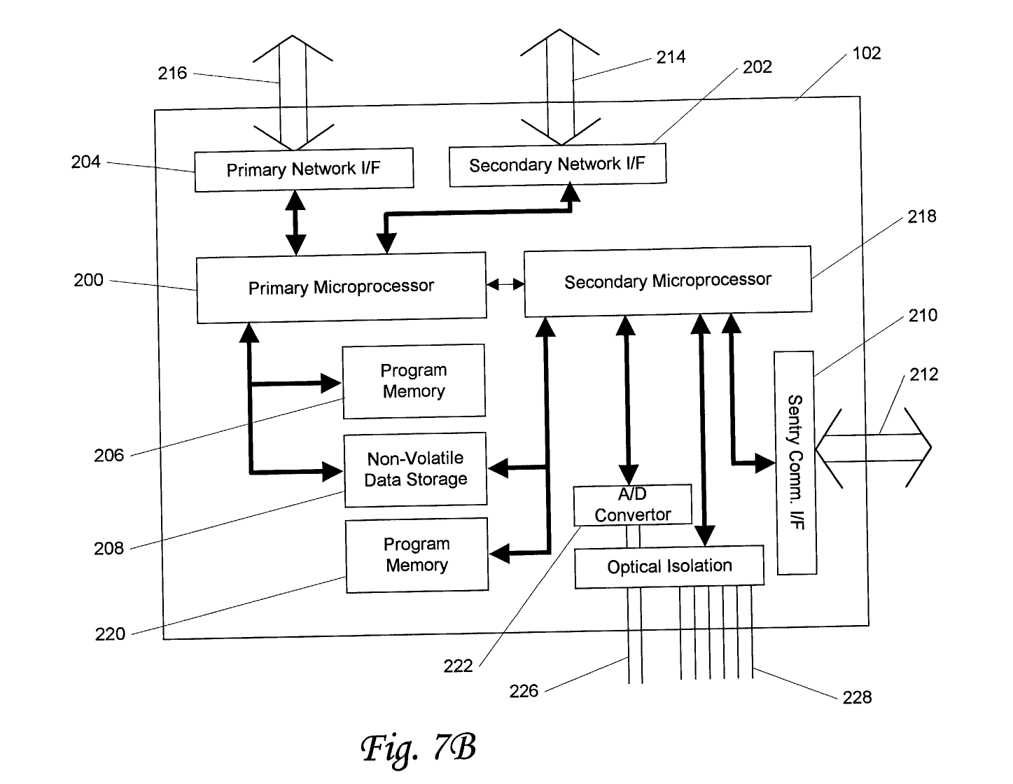

FIG. 8 shows an example system configuration with data links. The host computer, 104, is coupled to the watch commanders, 102A & B, via communications links, 138. In this instance links 138 would be implemented by RS-232. This protocol is appropriate for short distance, point-to-point connections as when the communicating nodes are collocated. Link, 140, couples a watch commander, 102A, to a series of sentries, 100A, in a multi-point configuration. RS-485 is used here as it provided the multi-point capability and longer distance. Multi-point connections are allowed for in the high level protocol through the use of node IDs. This is discussed below. Watch commander, 102B, is connected to sentries, 100B, via communications links 142. RS-422 is used to provide long distance, point-to-point connections. The low level protocol may be selected to be used for a particular link on a link by link basis depending on the distance, number of devices, and amount of ambient electrical noise. This flexibility also allows for option in the media used for the connection. Twisted copper pair, coaxial cable, fiber optic, etc. may be selected as appropriate.

In an alternative embodiment, redundant communications links may be provided between a master-slave pair. The redundant link may be a second connection of the same type, or may utilize different media and/or different protocol. One example of this is to provide a redundant connection between the host computer and a watch commander, which is not collocated, utilizing a cellular telephone connection. This provides a communications path which would bypass the physical connection which is typically used, avoiding problems such as cut phone cables. This would be especially important where the alternative embodiment also incorporates control capability allowing it to command the functional system. Utilizing the redundant link, a remote parking lot could be secured even if conventional communications is lost.

The high level protocol is layered on top of the low level protocol, providing a uniform approach to data transfer at the software level. The same basic protocol is used both between the host computer and the watch commanders, and between the watch commanders and the sentries. This simplifies both development and maintenance of the communications software/firmware.

The high level protocol utilizes a master-slave approach that is fully synchronous. The higher level node in the architecture maintains full control over the communications with its attached lower level nodes. Active polling is used to initiate data transfer in either direction. This has the advantage of being simple to implement at the lower levels, as no conflict resolution logic is required, and providing health and status monitoring of idle subsystems. The master will poll each slave subsystem in turn, either supplying data or requesting data. The slave will always respond to every command. The response may be an acknowledgment that data was received; an affirmative response indicating that data needs to be uploaded; or a negative response indicating an error or that no data needs uploading. All commands and data transfer packets include a checksum, or similar error detection code, allowing the packet to be verified by the recipient. Failure of a slave to respond indicates a failed node or failed communication link which can be reported for corrective action. When the system is idle, this periodic polling with required response serves as a “heartbeat” providing health and status information for all nodes in the system. This approach contributes to the overall reliability of the system because a failure within a node can be detected externally to the node.

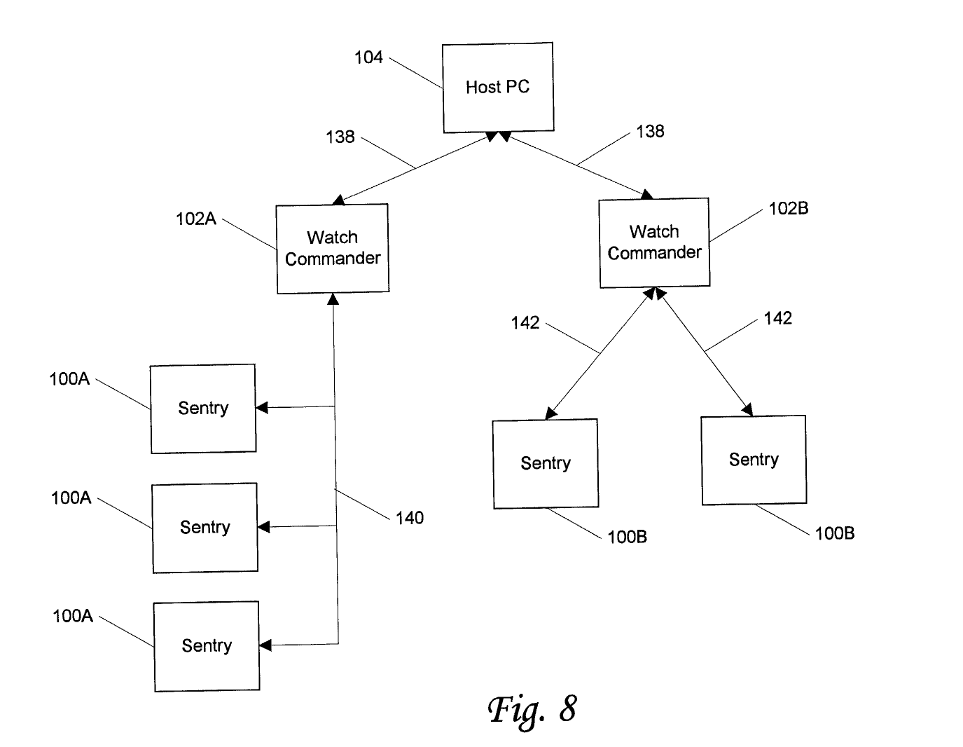

The basic communication packet formats are shown in FIGS. 9A-9D. These formats are used at all levels of the system. The standard packet used for a master to slave data transfer or command is illustrated in FIG. 9A. The packet consists of the SOH character, 144, marking the start of the packet. This is followed by the byte count, 146, which indicates the total number of bytes in the packet. The use of the byte count field allows the packets to be variable length. The node ID, 148, identifies the recipient of the packet. The data/command field, 150, contains the actual command being transferred. It may also include the data associated with the command. The checksum field, 152, is calculated from the actual values of the preceding fields, allowing error detection and correction. Use of other schemes, such as cyclic redundancy checks, is anticipated.

The normal response to a poll by a master is to return any buffered event reports. Where the slave is a sentry, these will be events detected and recorded by the sentry. Where the slave is a watch commander, the events will be those reported by sentries attached to the watch commander and previously reported by them. The format of a data reporting packet is shown in FIG. 9B. The SOH, byte count and checksum fields, 144, 146 and 152, are as described above. The node ID field, 148, now identifies the node from which the data is being transferred. The time stamp field is a complex field with the format shown in FIG. 9C. It comprises a time field, 156, indicating the time at which the event occurred; a node ID, 158, identifying the reporting node; a device ID, 160, identifying the input pin (device) indicating the event; and a device action code, 162, which specifies the type of event which occurred. The level of detail available in these event records allows very detailed report generation reflecting the states and changes for every functional component being monitored. This will be discussed more fully below.

A slave subsystem may also respond to a poll by sending an alarm report, shown in FIG. 9D. This differs from an event report in that it reports the occurrence of an event which has been identified by the sentry as an error or alarm. This is possible because the sentries may be tailored to the type of functional component which they are monitoring. This tailoring can include specification of out of range values or invalid sequences. As discussed above, the sentry can generate an output signal in response to such a condition. It can also generate an alarm report. Alarms may also be generated by watch commanders as a result of a combination of data received from multiple sentries.

In addition to polling, which reports a state change for a device (input line) only when it is detected, the protocol also allows for specific status requests. These would typically be generated by the host computer, passed through the watch commander to the sentry, which then reports the current state of the specified device. The sentry can also be requested to transfer a known set of data to verify the communications links. Time synchronization commands are available to propagate a standard time across all subsystems, providing uniform time stamps on the event reports.

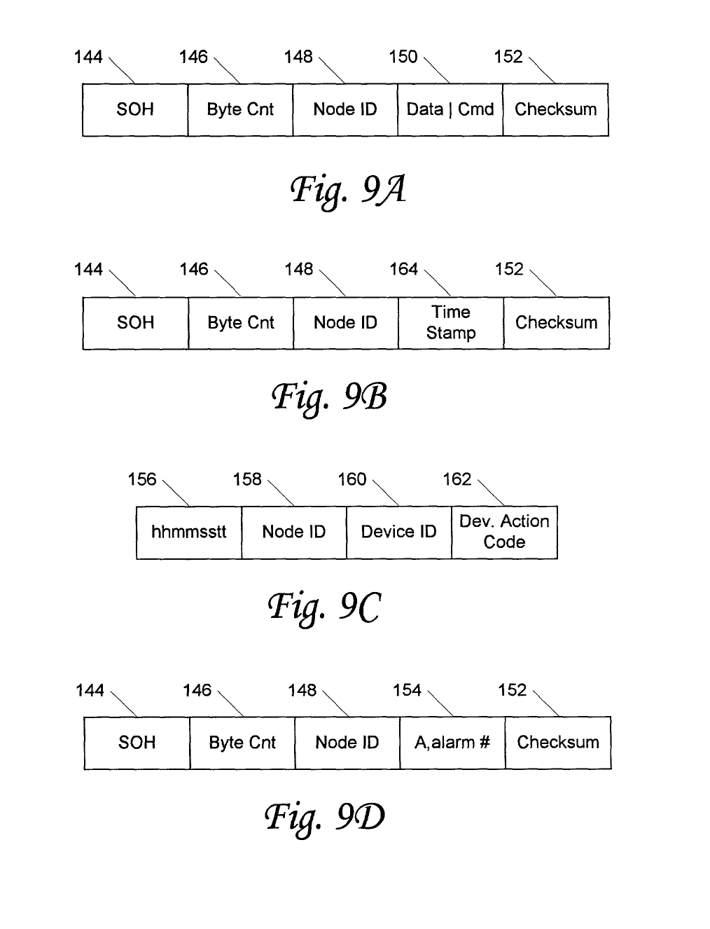

The basic command set for the sentry is shown in FIG. 10A and for the watch commander in 10B. These command sets are very similar, differing only in the commands unique to the subsystem. These command sets may also be extended for specific devices. An example of this is where the sentry is tailored to monitor an access card reader with an embedded processor. This “smart” card reader is capable of reported extensive health and status information not typically available from a functional component. Additional commands would be implemented to provide access to this information.

In addition to the node specific commands discussed above, the high level protocol also supports a broadcast capability for addressing multiple nodes at once. This is how the time synchronization will typically be performed. There are several node addresses which are reserved for broadcast purposes. In addition to a universal broadcast, recognized by all nodes, there are a series of addresses used for class broadcasts. A node can be defined to be a member of a class. Specific commands can then be sent to all members of that class with a broadcast command which is ignored by members of other classes.

The protocol is defined to use ASCII characters for all transfers. The commands are defined as ASCII codes. Non-ASCII data, such as times and device IDs are translated prior to transfer. This approach results in all of the communications utilizing human readable data. This greatly simplifies integration, debugging, and troubleshooting of the system as the data and commands are directly readable. A few characters, such as the SOH (a control-A in the preferred embodiment) are not directly readable, but are easily recognized.

Software Architecture

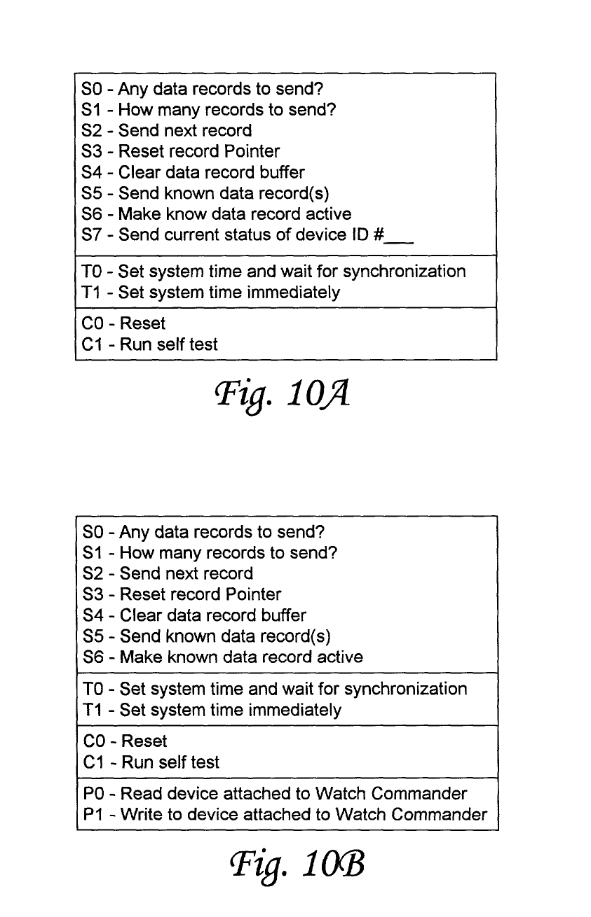

The software component of the invention is generally divided into the areas of device drivers; status monitoring; data management; transaction processing; database management; report generators; and user interface. As shown in FIG. 11, the software elements are hosted at all three levels of the hardware architecture. The host computer, 104, executes the user interface, 154; report generators, 156; database management, 158; and transaction processing, 160, segments of the software. The device drivers, 162, execute on the host computer, and watch commander. The data management software, 164, is resident on both the watch commander and sentry. The status monitoring software, 165, resides on the sentry.

The status monitoring software, 165, handles the low level communication with the hardware inputs such as the analog, 120, and discrete, 122, inputs shown in FIGS. 4A & B. In alternative embodiments of the sentry which incorporate an FPGA, some or all of the functions of the status monitoring software may be performed by the FPGA.

The device drivers, 162, handle the communications between the various components of the inventive system. It is this portion of the software which implements the high level communications protocol discussed above. In the preferred embodiment there is a different device driver for each type of communications link that is used. There may also be customized versions to support specific devices, such as the smart card reader disclosed above. Because the architecture utilizes the same protocol at all levels, the same device drivers can be reused, saving development and maintenance costs.

The data management segment, 164, is also reused across the watch commander, 102, and sentry, 100, subsystems. The data management software buffers data received from lower levels via the device drivers and coordinates the communication with higher levels. One of the primary functions of the data management software is to receive, interpret, and respond to commands received from the higher level network master. It can also perform basic analysis of received events.

The transaction processing segment, 160, performs several tasks which are central to the system. This software receives all incoming data and event reports generated throughout the system. The reports are examined to determine whether an alarm should be triggered and are then passed to the database management segment, 158, for storage. Multiple rule sets may be used to examine the incoming reports. The rules specify criteria which must be matched to trigger the rule and specify the action to be taken. The criteria may use data from the received report as well as data stored in the database. Actions may include triggering alarms or messages to be sent to an operators console; generating a report for output; or automatically reallocating system resources to patch around a detected problem. In an alternative embodiment, the transaction processing segment can also provide services to the functional system such as granting access or egress permission for a patron or calculating fee amounts. Because these decisions and calculations can be based on system-wide information stored in the database they can be more accurate and reliable.

The database management segment, 158, provides long term storage for the system. Information is maintained for: status of components for the functional system; status of components of the inventive monitoring system; customer status, vehicle ID, and billing; employee status; and all transactions. This set may be extended as desired. Also included in the database is system information such as logical addresses for watch commanders and sentries; identification numbers for recognized access control cards; and correspondence between device ID's in the monitoring system and components of the functional system. This data provides the basis for a wide range of both short term and long term reports. In the preferred embodiment, a commercial relational database management program is used to implement much of this software segment. As is well known in the art, other database products, including non-relational schemas, flat file, and proprietary storage systems could also be used.

The user interface, 154, and report generators, 156, provide for user interaction with the system. “Users” include system operators and managers who operate and maintain the system; attendants who use the system while performing their job; and customers who interact with the system while entering or exiting. The user interface comprises the interactive screens which support the operational use of the system. Report generators format data into pre-selected formats for viewing and can draw data from a current event report or from the database. Reports generally are divided into three categories: real time; periodic; and on-demand. Real time reports are those generated in response to a received event. These would include notification of a failure in a functional component; notification of a failure in a monitoring component, such as a sentry; or notification that a customer is attempting to re-enter a lot without having exited. Also included in this category are screens which can be displayed to a customer, such as on a smart card reader, which could provide a greeting or account status information. Periodic reports are those generated repeatedly, whenever the specified time period has elapsed. Typical periods would include daily, weekly, monthly, and yearly. These reports would draw on values stored in the database to provide summaries and compilations for the period in question. Because of the wide range of data stored by the inventive system, a variety of reports can be generated. Examples include: revenue summaries by parking lot; customer use profiles; and equipment failure reports. On-demand reports will be generated when requested by an authorized user of the system. Typical uses for on-demand reports include trouble shooting and long term analysis. The available data supports diverse reports including usage patterns by parking lot or by customer; trend analysis to show shifts in type of customer (daily or monthly) or method of payment; failure analysis to correlate equipment failures to location or type of equipment; as well as many others. Report format and content can be tailored by authorized system users to meet their specific needs.

Features and Functionality

The system has been designed to address several goals. It is easily retrofitted to an existing functional system. Once in place, it provides an independent reporting path for fault detection. This “side looking” approach avoids the situation where a built in test fails to report a fault because the fault has impacted the processing or communications functions. The sentries provide a uniform monitoring interface to the functional components, simplifying integration and control. The sentries can also be adapted to monitor functional components at many levels of the functional system; from basic components such as an access gate to intelligent card readers and fee computers. The system is also self monitoring. The communications protocol, incorporating periodic polling and explicit acknowledgments, provides a simple mechanism for detecting a component which is not longer responding due to an internal fault or failed communication link. Provision for redundant communications links between subsystems allows for recovery from some faults. Time synchronization across the system enables analysis based on data originating in diverse parts of the system.

The design of the system makes possible a range of health and status monitoring; analysis; and functional operations by providing data access at many levels. As discussed above, the design of the sentry subsystem allows it to capture detailed information concerning analog, digital, and mechanical status of a functional component. This can be achieved by monitoring existing power and control lines and by adding sensors. This detailed information is available directly to the sentry and is tagged and reported up the hierarchy for use in combination with data from other parts of the system. Because each event report is tagged with the sentry ID, device ID, and time at which it originated, a very detailed picture of the functional system at any point in time can be generated.

By comparing detected events to its internal rule set, a sentry can detect and report a fault in the component it is monitoring. In an alternative embodiment it can also generate output signals in response to the error. The output signal could attempt a correction, such as by resetting a control processor, or implement a safety procedure, such as by removing power from the component.

A watch commander has access to all of the event reports generated by its connected sentries. Using this data, it can apply its own rule sets to detect more broadly based problems. As an example, a watch commander may have available event reports for all functional components at one entrance of a parking lot: gates; ticket dispensers; card readers; etc. As a simple example, it can detect and report a situation in which an access card is correctly read and validated, but the gate failed to open. If the fault is in the cabling connecting the card reader and the gate, each component would appear to be working correctly (and in fact may be) but there is a failure in the system.

At the host computer, event reports from across the system are received and stored. These may be analyzed as they come in, again matching rules sets, or they may be retrieved from the database at a later time for analysis. The breadth and detail of data available enables types of fault detection not typically available in a functional system.

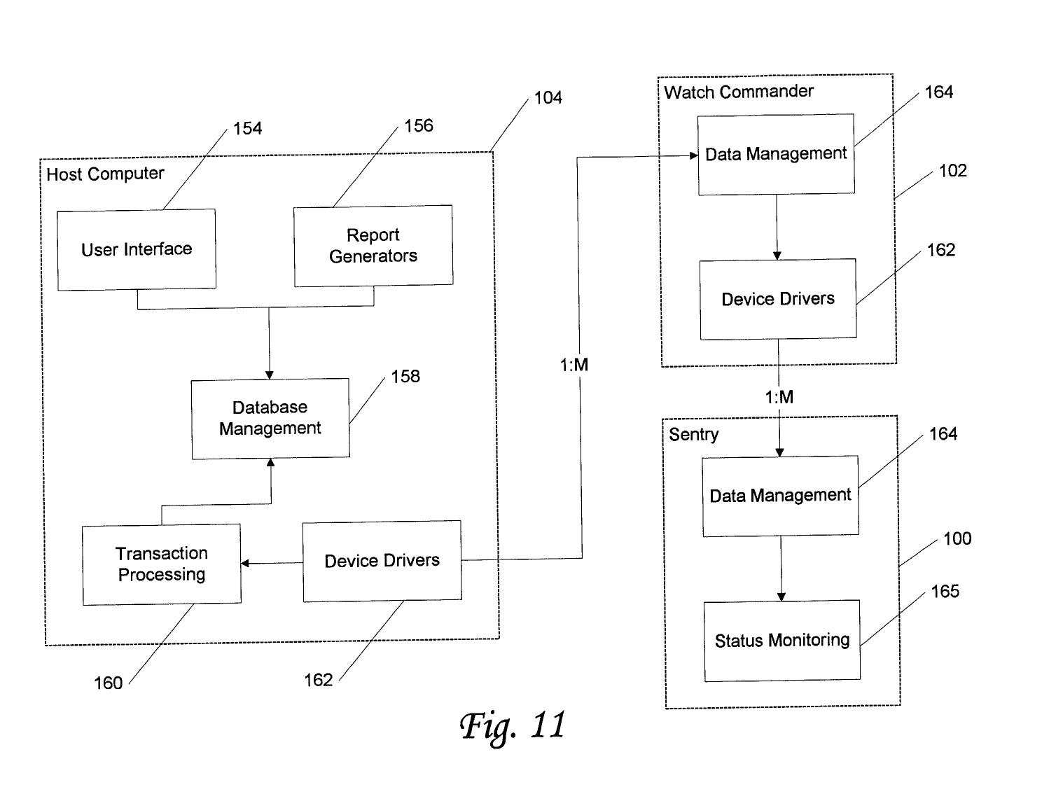

One type of monitoring that can be performed by the system is the use of time periods for validating the operation of the functional system. FIG. 12A illustrates a pair of signals which correspond to the output signal of a card reader, 166, commanding a gate to open and the switched power to the gate motor, 168, which opens and closes the gate. These signals have been simplified for illustrative purposes. The pulse, 172, represents the command to open the gate. Shortly thereafter, the rise, 174, in the switched power signal indicates that the gate has begun opening and then the drop, 176, in the signal indicates that the gate is open and the motor stopped. Similarly, the later rise, 178, and fall, 180, in the motor signal indicate that the gate has correctly closed. The distance between the various rises and falls in the signals correspond to the time elapsed between the events. Each of these rises and falls can be reported by sentry as a time stamped event and can be used for fault detection analysis.

FIG. 12B illustrates the same pair of signals with a change in the switched power signal. In this case, the rise, 174, occurs at the same time relative to the signal pulse, 172, from the card reader. However, the fall, 176′, in the signal occurs significantly later than in the original timeline of FIG. 12A. This indicates that the motor remained powered on for a longer time. A similar, though less significant change has occurred in the time between the rise, 178′, and fall, 180′, for the closing of the gate. Several possibilities could explain this change: a worn motor; increased friction in the gate bushings; or even ice or snow build up on the gate, making it stiffer. Once the change in timing has been detected, a service call can be scheduled for that gate to determine the exact problem and correct it. Without this type of monitoring, the problem would likely remain undetected until a complete failure occurred.

FIG. 12C illustrates a second, similar problem. While the time lapse between the rise and fall pairs is unchanged from the original, the duration between the completion of the gate opening, 176, and the start of the gate closing, 178″, has lengthened. This may indicate a problem with the timer circuitry for the gate or possibly tampering. Where this period becomes long enough, a second vehicle may be able to pass through. Where this is an exit gate, this can directly result in lost revenue. If detected before the duration becomes long enough, no revenue need be lost. Even if detected afterward, the revenue loss may be minimized by immediately correcting the problem. Here too, without the monitoring system this problem could remain undetected for a long period.

The analysis and detection of these two types of problems could be performed at any level of the system, from the sentry on up, because it requires data from only a single functional component. The allowed time periods can be stored using any of several well known techniques. These include the use of data files or static memory and storing either minimum and maximum allowed times or an expected time with an allowed deviation. Similar analysis can also be performed using data about two or more functional components, either from a single sentry or multiple sentries.

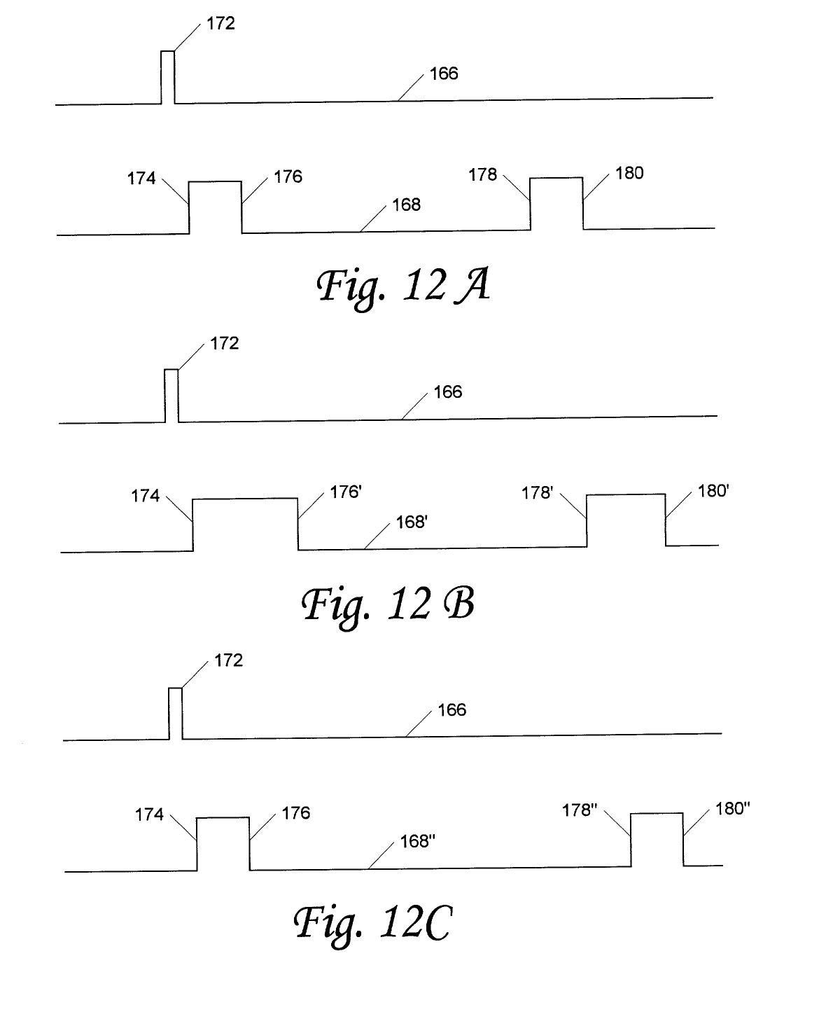

FIG. 13A & B illustrate a different type of timing problem, that of invalid sequences. This more complex problem would be detectable by analysis of multiple event reports, rather than by simple monitoring. Here the card reader and gate are viewed as a system. The state diagram of FIG. 13A shows the allowed sequences for that system. Where a valid access card is presented and accepted, the system will move from the idle state, 182, to the card accepted state, 184, in which the gate will be activated. After the gate is opened, the gate open state, 186, is entered where the system waits for the expiration of a timer to transition to the gate closed state, 188, after which it returns to the idle state to wait for the next customer. FIG. 13B illustrates an illegal transition, 190, for this simple system. Moving directly from the gate open state to the idle state is invalid because it leaves the gate open. Where this is detected by analyzing the available data, it can be reported or possibly automatically corrected by generating a “gate close” signal to the gate through its attached sentry. This type of invalid sequence could be handled by either a watch commander or the host computer.

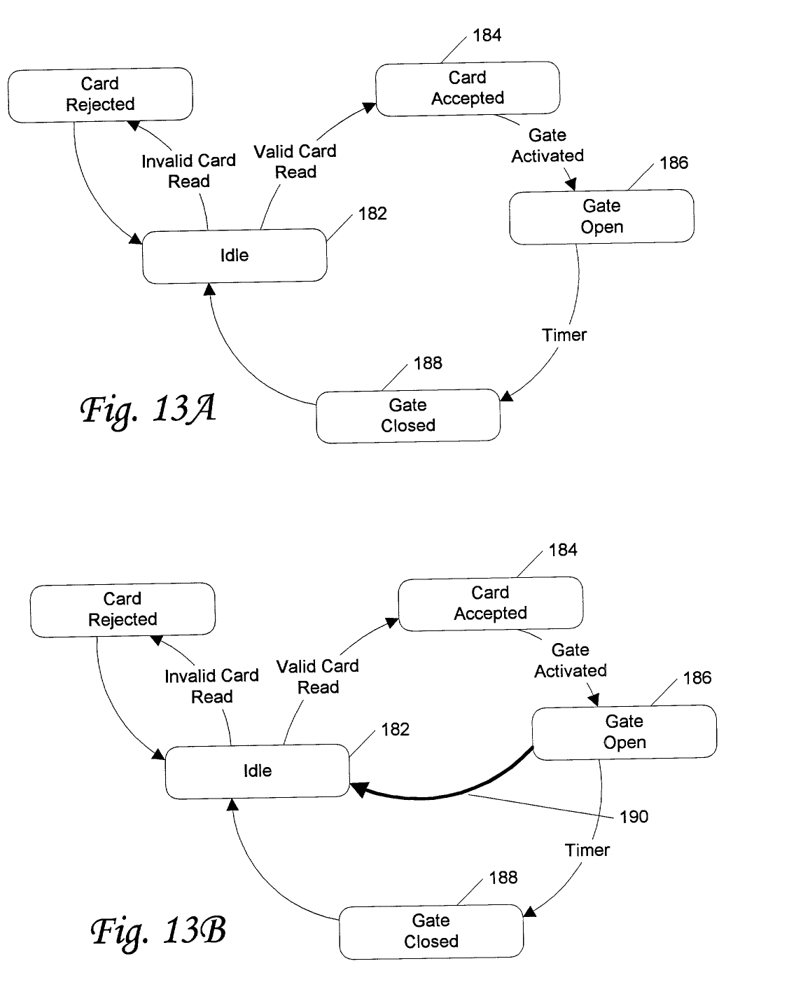

FIGS. 14A presents a similar state model showing the allowed sequences for a monthly parking customer, which also serves as a basis for analysis. The model reflects the state of the customer as they move in and out of the parking lot(s) monitored by the system. FIG. 14B illustrates two invalid sequences. Transition, 192, indicates that a customer that is currently parked in a lot is trying to re-enter that lot, or another lot, without having first exited. This may indicate an equipment failure, if the customer actually did exit, perhaps through a gate that is stuck open, or it may indicate fraud, as when a customer loans their card to a friend so that they can also park. This type of problem can be detected by some current systems for a single lot, but not where a single access card may be honored at more than one lot.

Transition, 194, is a similar situation. It reflects an attempt to exit twice without reentering. Again this may be equipment failure. It may also reflect a customer who entered by taking a ticket from the dispenser but then tries to exit with their access card. This situation may indicate a failed entry access card reader that would not let the customer into the lot. This may also indicate a fraud problem where a customer lends an access card to a friend to allow them to leave without paying. Other sequence analyses can also be developed based on system wide changes in customer states, equipment states and combinations. This type of analysis would typically be performed by the host computer since it alone would have access to the entire system. The ability to perform this type of analysis can make viable such concepts as multiple lot access cards which previously were impractical because they were too susceptible to fraud and abuse.

The allowed states can be stored using a variety of known techniques. These include state transition tables, often implemented as two dimensional arrays with states as row and column numbers; and adjacency lists in which link lists represent the state transition diagram with links representing the transitions. The storage and verification can also be implemented in a custom logical process engine which utilizes an ASIC, or other, circuit design to monitor and validate the sequence of events.

The data gathered by the inventive system can also be used for functional operations such as revenue tracking and market analysis. Because information is available as to when a customer entered a lot, and when they left (or are requesting to leave), the fee for that visit can be easily calculated. This can be done for daily customers and also for monthly customers. The calculated fee can be provided to the operational system, or the attendant, for use, or it can be treated as a redundant calculation to validate the revenue calculations and actual income of the functional system. The available data would enable revenue models such as a pay per use or pay per hour in addition to traditional fixed rate schemes. The same data can also be used to develop market analysis information. Models of when certain customers use a parking lot, or when parking lots at particular locations are full or empty can then be used to predict future capacity needs or to identify untapped revenue sources, such as unused monthly spaces during the evening hours when the daily spaces are exhausted.

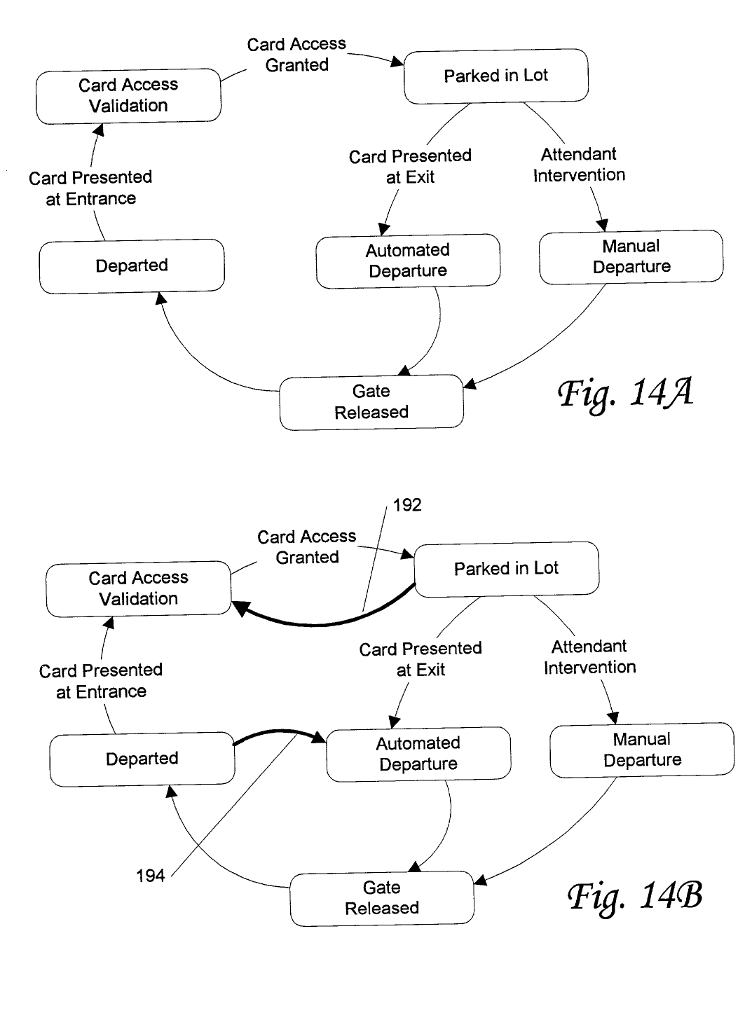

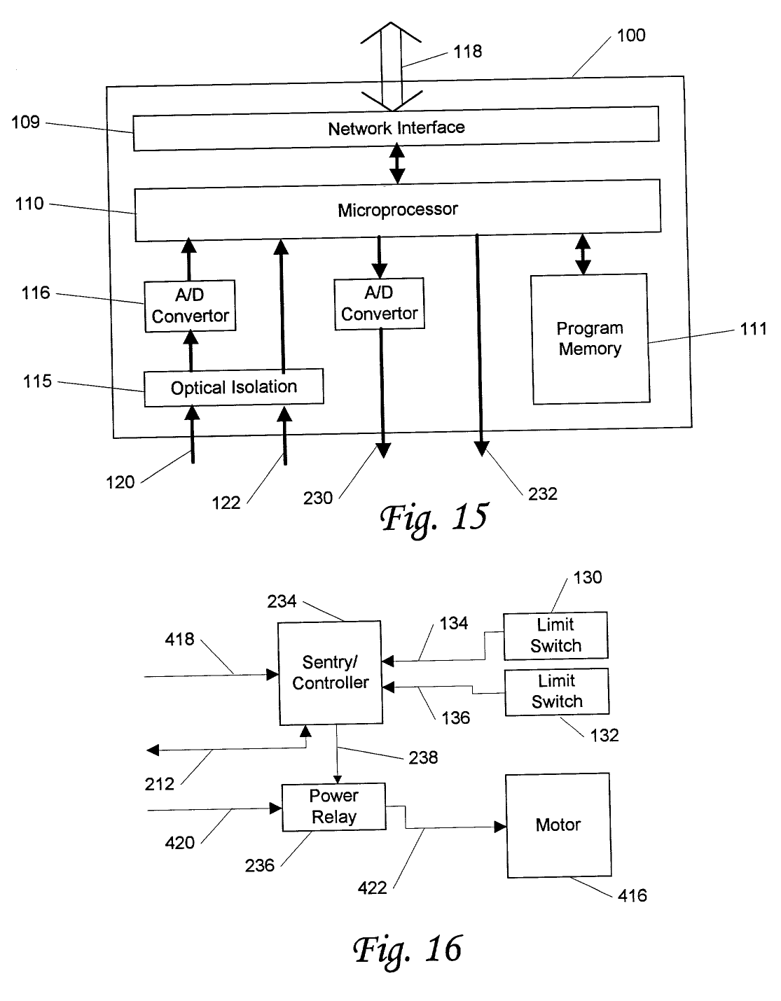

The sentry can also be built in a version which incorporates control capability. As FIG. 15 illustrates, this version includes analog, 230, and discrete, 232, outputs. This allows the sentry to control external devices. One application of this capability is shown in FIG. 16. This is the same application discussed above with reference to FIGS. 5 & 6. In this case, however, the functional controller, 414 in FIG. 5 has been replaced by the alternative form of sentry shown in FIG. 15. The unswitched power, 420, is connected to an external power relay, 236, which then supplies switched power, 422, to the motor, 416. The control signal, 238, for the power relay is connected to one of the outputs, 232, of the sentry, allowing the sentry to control the motor. The functional input control signal, 418, is coupled to an input, 120 or 122 as appropriate, of the sentry. The sentry is then programmed to respond to the functional input signal by applying power to the motor to raise and lower the gate. The communications interface, 212, limit switches, 130 and 132, and their discrete inputs, 134 and 136, function as described above. In this configuration the sentry serves as a retrofit controller for the functional system, which is plug compatible with the original controller. It also serves as a sentry to the inventive monitoring system, providing full monitoring capability. A significant added benefit of this configuration is that the sentry/controller can be commanded through the monitoring network and caused to perform its functional operations. In this way, if the functional command link, 418, to the controller is lost, the monitoring system can be used as a redundant connection to maintain full functional capability until the damaged link is repaired. This configuration could also, of course, be used as the primary control circuit.

A further alternative is to implement the sentry, and possibly the watch commander, as parts of the functional component during manufacture. The monitoring subsystem can be implemented as either a board level or a chip level component which can then be integrated into the functional controller during manufacture.

The inventive system has been extensively discussed with respect to its applicability to parking systems. It is equally applicable to other systems which need supplemental monitoring. One such application is monitoring crossing gates at train or light rail crossings. A relatively simple system could generate a time-tagged log of when gates opened and closed. Such information would be invaluable in resolving liability issues where there is a train-car collision at a crossing. This could also be true of traffic intersection signals and pedestrian signals. The system is also adaptable to manufacturing, process control, and other functional systems.

While the preferred form of the invention has been disclosed above, alternative methods of practicing the invention are readily apparent to the skilled practitioner. The above description of the preferred embodiment is intended to be illustrative only and not to limit the scope of the invention.

We claim:

1. A monitoring system, for use with a functional system comprised of functional components, comprising:
(a) at least one monitoring node comprising a general purpose microcomputer, plural discrete input connections coupled to said microcomputer, and a first communications interface providing data input and output to said microcomputer, said monitoring node adapted to be connected to one of the functional components;
(b) status monitoring means for detecting and reporting input value changes on said discrete inputs;
(c) at least one data collection node comprising a general purpose microcomputer, a second and a third communication interfaces, providing data input and output to said microcomputer, said second communication interface in communication with said first communication interface;
(d) data management means in communication with said status monitoring means which receives said input value change reports and transmits said reports using said communication interfaces;
(e) a general purpose host computer comprising a fourth communication interface, said fourth communication interface in communication with said third communication interface;

2. The monitoring system of claim 1 wherein said monitoring node further comprises one or more analog input connections and said status monitoring means also detects and reports input value changes on said analog inputs.

3. The monitoring system of claim 1 wherein said data management means comprises a first software segment executing on said microcomputer in said monitoring node and a second software segment executing on said microcomputer in said data collection node.

4. The monitoring system of claim 1 wherein said data management means further comprises input validation means which analyzes said input value changes and reports invalid events.

5. The monitoring system of claim 4 wherein said input validation means comprises means to compare said input values against acceptable values for said input values.

6. The monitoring system of claim 4 wherein said input validation means comprises means to compare the relative timing between two of said input value changes to acceptable timing.

7. The monitoring system of claim 4 wherein said input validation means comprises means to compare the sequence in which said input value changes occurs to acceptable sequences.

8. The monitoring system of claim 7 wherein said comparison of sequences analyzes input value changes detected by at least two different monitoring nodes.

9. The monitoring system of claim 1 further comprising transaction processing software executing on said host computer which receives said input value change reports from said data management means and analyzes said input value change reports.

10. The monitoring system of claim 9 wherein said host computer further comprises non-volatile mass storage means and wherein said transaction processing software further stores said input value change reports in said mass storage.

11. The monitoring system of claim 10 wherein said analysis performed by said transaction processing software utilizes at least one of said received input value change reports and at least one of said stored input value change reports.

12. The monitoring system of claim 9 wherein said transaction processing analysis comprises comparison of the relative timing between two of said input value changes to acceptable timing.

13. The monitoring system of claim 9 wherein said transaction processing analysis comprises comparison of the sequence in which said input value changes occurs to acceptable sequences.

14. The monitoring system of claim 13 wherein said transaction processing analysis analyzes input value changes reported by at least two different data collection nodes.

15. The monitoring system of claim 1 wherein said monitoring node further comprises a programmable gate array coupled to said discrete inputs and said programmable gate array provides said coupling between said inputs and said microcomputer.

16. The monitoring system of claim 1 wherein said data collection node further comprises a fifth communication interface which provides a redundant communications link to said host computer.

17. The monitoring system of claim 1 wherein said monitoring node and said data collection node are implemented within a single printed circuit board.

18. The monitoring system of claim 1 wherein said communication between said first and second communication interfaces and between said third and fourth communication interface utilize the same high level protocol.

19. The monitoring system of claim 18 wherein said protocol comprises means for detecting when a lower level node fails to respond.

20. The monitoring system of claim 19 wherein said nodes further comprise an internal clock and said protocol comprises means for synchronizing said internal clocks.

21. A monitoring and control system, for use with a functional system comprised of functional components, where at least some of the functional components include a control element which responds to functional input signals, comprising:
(a) at least one monitoring and control node comprising a general purpose microcomputer, plural discrete input connections coupled to said microcomputer, plural discrete output connections coupled to said microcomputer, and a first communication interface providing data input and output to said microcomputer;
(b) status monitoring means for detecting and reporting input value changes on said discrete inputs;
(c) at least one data collection node comprising a general purpose microcomputer, a second and a third communication interfaces, providing data input and output to said microcomputer, said second communication interface in communication with said first communication interface;
(d) data management means in communication with said status monitoring means which receives said input value change reports and transmits said reports using said communication interfaces;
(e) a general purpose host computer comprising a fourth communication interface, said fourth communication interface in communication with said third communication interface;
wherein said monitoring and control node is adapted to replace the control element and to respond to the functional control signals in the same manner as the replaced control element.

22. The monitoring system of claim 21 wherein said monitoring and control node further responds to control commands received from said first communication interface in the same manner as it responds to the functional control signals.

23. The monitoring system of claim 22 further comprising transaction processing software executing on said host computer which receives said input value change reports from said data management means and analyzes said input value change reports and when said analysis detects a failed functional component, assumes control of the functional component by transmitting said control commands to said monitoring and control node coupled to the functional component.

24. The monitoring system of claim 22 further comprising transaction processing software executing on said host computer which receives said input value change reports from said data management means and analyzes said input value change reports and when said analysis detects a failed functional component, activates a second functional component to replace the failed functional component.
